(19) United States
(12) Patent Application Publication
(10) Pub. No.: US 2006/0286890 A1
(43) Pub. Date: Dec. 21, 2006

(54) Lamp assembling apparatus and method thereof

(76) Inventors: Choun-ho Ok, Hwaseong-si (KR); Gap-soo Lee, Suwon-si (KR); Heong-seog Lee, Suwon-si (KR)

Correspondence Address: STANZIONE & KIM, LLP, 919 18TH STREET, N.W., SUITE 440, WASHINGTON, DC, 20006, US

(21) Appl. No.: 11/342,548

(22) Filed: Jan. 31, 2006

(30) Foreign Application Priority Data
Jun. 15, 2005 (KR) 2005-0051342

(51) Int. Cl. H01J 9/46; H05B 33/10; H01J 9/36

(52) U.S. Cl. 445/66; 445/69

(57) ABSTRACT

A lamp assembling apparatus that assembles a lamp unit of an optical engine having a lamp and a lamp housing to support the lamp, and includes an illuminator through which light emitted from the lamp of the lamp unit passes, a screen on which an image is formed by the light passed through the illuminator, a lamp control unit to adjust a position of the lamp with respect to the lamp housing, a lamp fastening unit to fasten the lamp to the lamp housing in a state that the lamp is adjusted in position by the lamp control unit, and a controller to determine the image formed on the screen and to control the lamp control unit and the lamp fastening unit to bring the lamp into focus and then fasten the lamp to the lamp housing.

### CROSS-REFERENCE TO RELATED APPLICATIONS

This application claims the benefit of Korean Patent Application No. 2005-0051342, filed on Jun. 15, 2005, in the Korean Intellectual Property Office, the entire contents of which is incorporated herein by reference.

### BACKGROUND OF THE INVENTION

1. Field of the Invention

The present general inventive concept relates to a lamp assembling apparatus of a lamp unit, and more particularly, to a lamp assembling apparatus in which a lamp is adjusted in position and coupled to a lamp housing of a lamp unit, and a method thereof.

2. Description of the Related Art

In general, an optical engine is mounted to a projection system such as a regular projector or a projection television to realize a picture and enlarge and project the realized picture onto a screen. Such an optical engine includes a lamp unit to emit light, an illuminator to focus the light emitted from the lamp unit, a display device to realize a picture with the light passed through the illuminator, and a projection lens to project the picture realized by the display device onto the screen.

Further, the projection system can be classified into different categories according to the methods used to realize a picture. For example, the projection system can be classified into a projection system that employs a cathode ray tube (CRT) for realizing a picture without using the lamp unit, a projection system that employs a display device such as a lamp unit, a liquid crystal display (LCD), or a digital micro-mirror device (DMD) for realizing a picture, etc.

Also, the lamp unit includes a lamp to emit the light, and a lamp housing to accommodate and support the lamp. The lamp is adjusted in position to be brought into focus, and then coupled to the lamp housing, thereby being mounted to the optical engine.

However, in the conventional lamp assembling apparatus, a user adjusts the position of the lamp against the lamp housing by using naked eyes to bring the lamp into focus, and then manually mounts the lamp to the lamp housing in the state that the lamp is brought into focus. Therefore, it is difficult to enhance productivity. Further, it is difficult to obtain uniform quality because the adjusted position of the lamp mounted to the lamp housing may be different in precision according to different users.

Also, in the conventional lamp assembling apparatus, an inspection process for inspecting the luminous intensity and the flicker of the lamp unit is manually performed by the user.

### SUMMARY OF THE INVENTION

The present general inventive concept provides a lamp assembling apparatus capable of enhancing productivity, securing uniform quality, and enhancing inspection quality.

Additional aspects and advantages of the present general inventive concept will be set forth in part in the description which follows and, in part, will be obvious from the description, or may be learned by practice of the general inventive concept.

The foregoing and/or other aspects of the present invention may be achieved by providing a lamp assembling apparatus to assemble a lamp unit usable with an optical engine, which comprises a lamp, and a lamp housing to support the lamp, the lamp assembling apparatus comprising an illuminator through which light emitted from the lamp of the lamp unit passes;, a screen on which an image is formed by the light passed through the illuminator, a lamp control unit to adjust a position of the lamp against the lamp housing, a lamp fastening unit to fasten the lamp to the lamp housing when the lamp position is adjusted by the lamp control unit, and a controller to determine a state of the lamp with respect to the lamp unit according to an image formed on the screen, and to control the lamp control unit and the lamp fastening unit to bring the lamp into focus and fasten the lamp to the lamp housing according to the state of the lamp.

The lamp control unit may comprise a lamp holder to hold the lamp in a state that the lamp is movably coupled to the lamp housing, and a holder transferring part to transfer the lamp holder to move the lamp relative to the lamp housing in a direction transverse to the light emitted from the lamp.

The controller may comprise an image detector to detect the image formed on the screen, and a position adjuster to control the holder transferring part by determining the image detected by the image detector.

The lamp housing may comprise a plurality of coupling parts to which a plurality of screws are coupled, and the lamp may comprise a plurality of coupling holes corresponding to the plurality of coupling parts and each coupling hole having a larger diameter than a threaded part of the screw.

The lamp fastening unit may comprise a screw fastener to fasten the screw to prevent the lamp from moving relative to the lamp housing, a fastener transferring part to support and transfer the screw fastener to allow the screw fastener to fasten the screw.

The controller may further comprise a fastening adjuster to control the fastener transferring part and the fastener to fasten the screw in a state that the lamp is adjusted in position by the position adjuster.

The holder transferring part may transfer the lamp holder in three axis directions.

The lamp assembling apparatus may further comprise a palette to support the lamp unit, and a transferring unit which comprises a guide to support and guide the palette, and a transferring member to transfer the palette along the guide.

The transferring unit may comprise a power supply placed along the guide to supply power to the palette, and the palette may comprise a power connecting part contactable with the power supply, and a connector electrically connected to the power connecting part and coupled to a cable of the lamp unit.

The lamp assembling apparatus may further comprise an aging process unit to age the lamp unit for a predetermined time, a lamp control process unit to adjust the position of the lamp and fasten the lamp using the lamp control unit and the lamp fastening unit after the lamp is aged, and a lamp inspection process unit to inspect the lamp unit after a lamp control process of the lamp control process unit.

The transferring unit may transfer the palette to the aging process unit, the lamp control process unit and the lamp inspection process unit.

The aging process unit, the lamp control process unit and the lamp inspection process unit may comprise aging, lamp control, and lamp inspection chambers, respectively, to prevent the light emitted from the lamp from being shown to an area outside the chambers.

The palette may comprise an accommodating part to accommodate a ballast and a lamp driving circuit of the lamp unit therein.

The lamp inspection unit may inspect at least one of the luminous intensity and a flicker of the light emitted from the lamp.

The lamp inspection process unit may further comprise a projection lens to project the light passed through the illuminator, an illumination sensor to sense the luminous intensity of the light projected from the projection lens, a flicker sensor to sense the flicker of the light projected from the projection lens, and an inspection display to receive and display sensed values from the illumination sensor and the flicker sensor.

The transferring member may comprise a chain contactable with the palette and a transferring motor to transfer the chain.

The foregoing and/or other aspects of the present invention may also be achieved by providing a lamp assembling apparatus comprising a lamp injecting part to provide a lamp unit in which a lamp is temporarily coupled to a lamp housing, an aging process unit to control an aging process of the lamp of the lamp unit, a control process unit having an image unit to form an image of the lamp unit using light, a lamp control unit to adjust a position of the lamp with respect to the lamp housing using the light between the lamp and the lamp housing, and a controller to bring the lamp into focus according to the image, an inspection process unit to inspect an assembly state of the lamp unit, and a lamp discharging part to discharge the lamp unit.

The foregoing and/or other aspects of the present invention may also be achieved by providing a method of a lamp assembling apparatus comprising forming an image on a screen by a light projected by a lamp, adjusting a position of the lamp against a lamp housing using the light, fastening the lamp to the lamp housing when the lamp position is adjusted in position, determining a state of the lamp according to the image formed on the screen, and bringing the lamp into focus and fastening the lamp to the lamp housing according to the state of the lamp.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a schematic front view illustrating a lamp assembling apparatus according to an embodiment of the present general inventive concept;

FIG. 2 is a detailed front view illustrating the lamp assembling apparatus of FIG. 1;

FIG. 3 is a plan view illustrating an upper transferring unit of the lamp assembling apparatus of FIG. 1;

FIG. 4 is a plan view illustrating a lower transferring unit of the lamp assembling apparatus of FIG. 1;

FIG. 5 is an exploded perspective view illustrating a lamp unit that is used in the lamp assembling apparatus of FIG. 1;

FIGS. 6 and 7 are perspective views illustrating a palette in the lamp assembling apparatus of FIG. 1;

FIGS. 8 and 9 are perspective views illustrating a lamp control unit in the lamp assembling apparatus of FIG. 1; and

FIG. 10 is a control block diagram of a controller in a lamp assembling apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

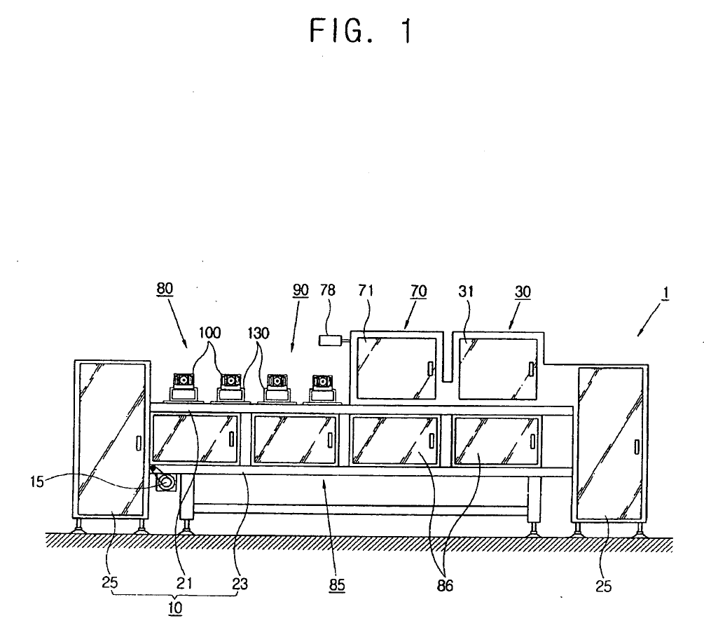

As illustrated in FIGS. 1 through 10, a lamp assembling apparatus 1 according to an embodiment of the present general inventive concept is used in assembling a lamp unit 100 used with an optical engine, a lamp inspection process unit 70, a transferring unit 10, a lamp control process unit 30, a lamp injection part 80, and a lamp discharging part 90. The lamp unit 100 includes a lamp 101, and a lamp housing 111 to support the lamp 101. Here, the lamp assembling apparatus 1 is configured to bring the lamp 101 into focus in the lamp housing 111 of the lamp unit 100. Referring to FIG. 1, the lamp assembling apparatus 1 includes an aging process of the aging process unit 85 to age the lamp unit 100 for a predetermined time, a lamp control process unit 30 to adjust a position of the lamp 101 and fasten the lamp 101 after the aging process unit 85, and a lamp inspection process of the lamp inspection process unit 70 to inspect the lamp unit 100 after the lamp control process of the lamp control process unit 30. Further, the lamp assembling apparatus 1 includes the transferring unit 10 to transfer the lamp unit 100 to the aging process unit 85, the lamp control process unit 30, and the lamp inspection process unit 70.

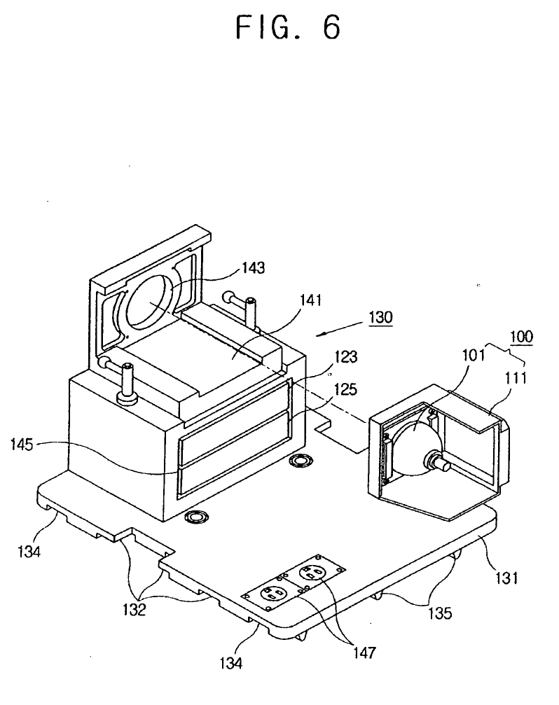

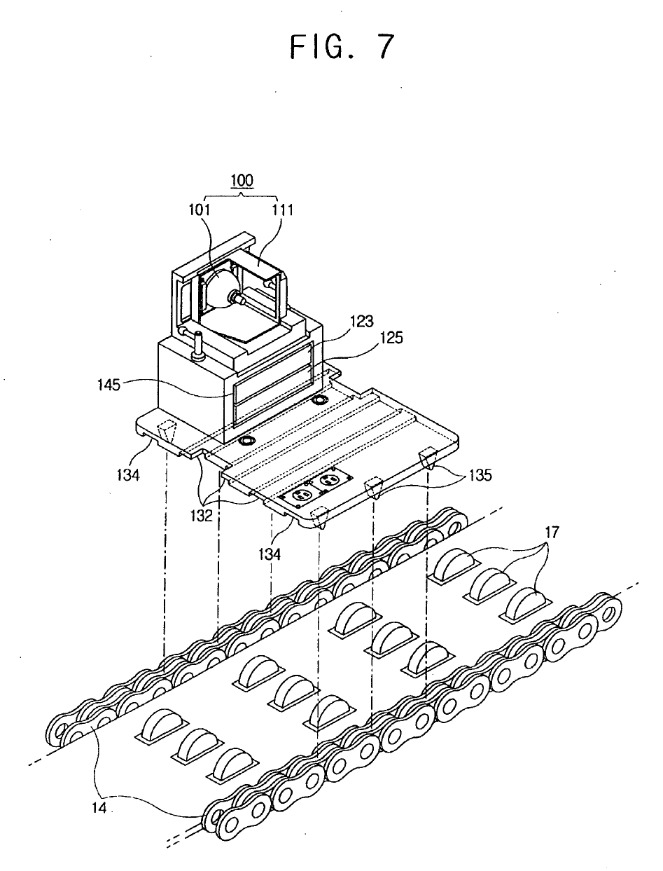

As illustrated in FIGS. 6 and 7, the lamp unit 100 emits light and is mounted to the optical engine used in a projection system such as a projector or a projection television. The lamp unit 100 includes the lamp 101, and the lamp housing 111.

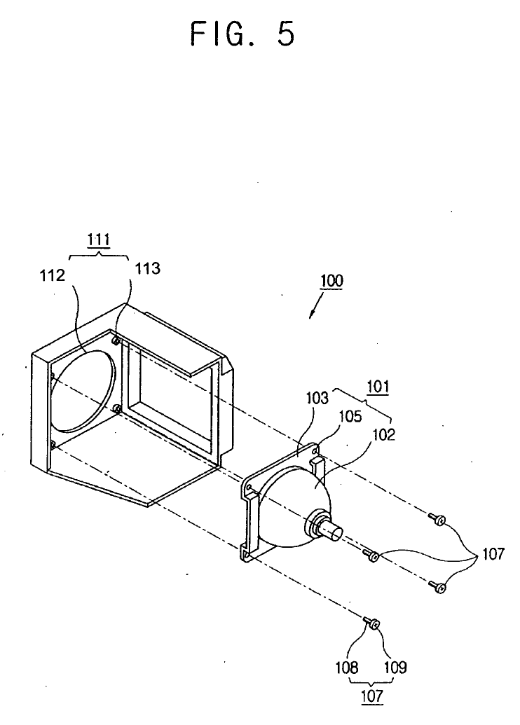

As illustrated in FIG. 5, the lamp 101 includes a lamp body 102 to emit the light, a lamp bracket 103 protruding outward from the lamp body 102 and coupled to the lamp housing 111, and a coupling hole 105 formed on the lamp bracket 103 corresponding to a coupling part 113 of the lamp housing 111.

As illustrated in FIG. 6 the lamp 101 receives power from the transferring unit 10, and is driven by a ballast 123 and a lamp driving circuit 125. The lamp 101 is provided with a cable (not shown) to be connected to a connector 147 of a palette 130, and thus receives the power from the transferring unit 10.

The lamp bracket 103 of FIG. 5 is shaped like a plate to be placed in contact with an outside of a housing through part 112 formed in the lamp housing 111. Here, the center of the lamp bracket 103 is penetrated to allow the light emitted from the lamp 101 to pass through the center of the lamp bracket 103.

A plurality of coupling holes 105 are formed on the lamp bracket 103 so that the lamp 101 may be coupled to the lamp housing 111 by a plurality of fastening screws 107. The coupling holes 105 have a larger diameter than a threaded part 108 of the fastening screws 107. Because the coupling holes 105 have a larger diameter than the threaded part 108 of the fastening screws 107, the lamp 101 can move a predetermined distance relative to the lamp housing 111 in the state that the lamp 101 is loosely coupled to the lamp housing 111 by the fastening screws 107. That is, a movable distance of the lamp 101 is determined by a difference in the diameters between the diameters of the coupling holes 105 and the diameters of the threaded part 108 of the fastening screws 107. Therefore the movable distance of the lamp 101 can be changed by adjusting the diameters of the coupling holes 105 and the threaded part 108 of the fastening screws 107. Further, the coupling hole 105 prevents a head part 109 of the fastening screw 107 from breaking away when the coupling holes 105 are coupled to the coupling part 113 with the fastening screws 107. For example, the coupling holes 105 have a smaller diameter than the head part 109 of the fastening screws 107.

The lamp housing 111 includes the housing through part 112 through which the light emitted from the lamp 101 passes, and the coupling part 113 provided outside the area of the housing through part 112 and to which the fastening screws 107 passing through the coupling holes 105 of the lamp 101 are coupled. In FIG. 6, the lamp housing 111 is seated on the palette 130 and is transferred by the transferring unit 10.

As illustrated in FIGS. 5 and 6, the palette 130 includes a base 131 seated on the transferring unit 10, a lamp supporter 141 provided on the base 131 to support the lamp housing 111, and a supporter through part 143 through which the light emitted from the lamp unit 100 seated on the lamp supporter 141 passes. The palette 130 is provided with the connector 147 to which the cable (not shown) of the lamp 101 is connected. Further, the palette 130 can be provided with an accommodating part 145 to accommodate the ballast 123 and the lamp driving circuit 125 therein.

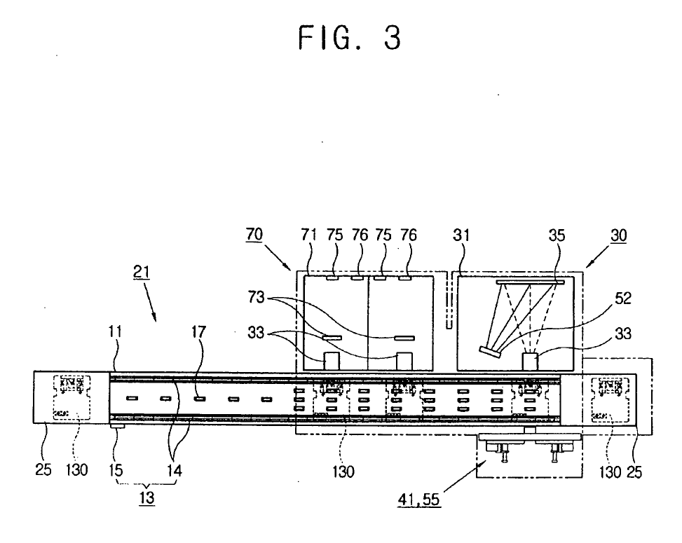

The base 131 includes a power connecting part 132 electrically contactable with a power supply 17 of the transferring unit 10 (FIGS. 3 and 7), and a transferring coupling part 134 to which a sub-transferring member 14 of a transferring member 13 of the transferring unit 10 (FIG. 7) is coupled so as to transfer the palette 130.

The power connecting part 132 may include a plurality of sub-power connecting parts corresponding to the respective power supplies 17 of the transferring unit 10. The power connecting part 132 is longitudinally recessed at the bottom of the base 131 along a transferring direction with respect to the transferring unit 10, and in which the recessed portion of the connecting part 132 is made of a conductive material to electrically contact the power supply 17. In this embodiment, by way of example, there may be three power connecting parts 132. Among the three power connecting parts 132, a middle one is a ground terminal, and the two opposite sides of the ground terminal are positive and negative terminals. Here, the power connecting part 132 is electrically connected to supply the power from the power supply 17 of the transferring unit 10 to the connector 147, the ballast 123 and the lamp driving circuit 125.

The transferring coupling part 134 is provided as a plurality of parts corresponding to the sub-transferring members 14 of the transferring member 13 of the transferring unit 10. The transferring coupling part 134 is longitudinally recessed at the bottom of the base 131 along the transferring direction. For example, a pair of transferring coupling parts 134 are provided outside the power connecting parts 132 in correspondence to the sub-transferring member 14. The transferring coupling part 134 is provided with a plurality of projections 135 which are inserted in and engaged with the sub-transferring member 14, e.g., shaped like a chain. Therefore, when the sub-transferring member 14 moves in a state where the plurality of projections 135 are inserted in the sub-transferring member 14, the palette 130 moves along with the plurality of projections 135.

As illustrated in FIGS. 1 through 4, the transferring unit 10 transfers the plurality of palettes 130 to the aging process unit 85, the lamp control process unit 30 and the lamp inspection process unit 70. The transferring unit 10 includes a guide 11 (FIG. 3) to support and guide the palette 130, and the sub-transferring unit 14 to transfer the palette 130 along the guide 11. The transferring unit 10 is provided with the power supply 17 arranged along the guide 11 so as to supply the power to the palette 130. According to the present embodiment, the transferring unit 10 includes an upper transferring unit 21 placed in an upper portion of the transferring unit 10, a lower transferring unit 23 placed under the upper transferring unit 21, and a vertical transferring unit 25 placed at opposite sides of the upper and lower transferring units 21 and 23 and transferring the palette 130 to the upper and lower transferring units 21 and 23 as illustrated in FIG. 1.

The guide 11 is provided in the upper and lower transferring units 21 and 23 to guide the plurality of palettes 130 in the transferring direction.

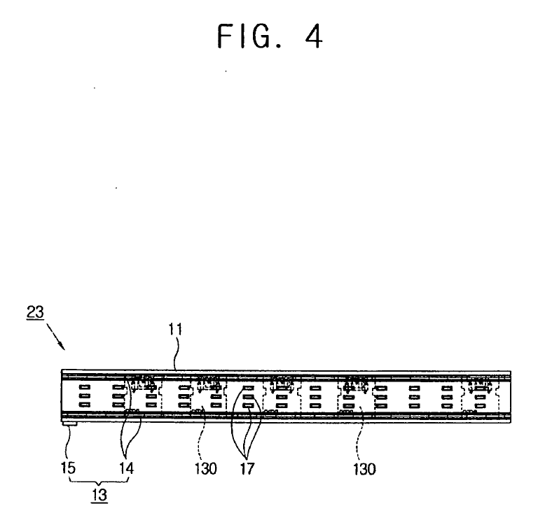

As illustrated in FIGS. 3 and 4, the sub-transferring member 14 is placed on the guide 11 and transfers the plurality of palettes 130 along the guide 11. According to the present embodiment, the sub-transferring member 14 includes the chain coupled to the projection 135 of the transferring unit coupling part 134 that transfers the palette 130 along the transferring unit 10, and a transferring motor 15 to transfer the sub-transferring member, such as the chain, 14. However, the sub-transferring member 14 is not limited to designs using the chain, and may be achieved by various methods such as a belt transferring method, etc., as long as it can transfer the palette 130.

The sub-transferring member 14 may include a pair of chains corresponding to the pair of transferring coupling parts 134 provided in the palette 130, and may be provided in the upper and lower transferring units 21 and 23.

The transferring motor 15 may also include a pair of motors 15 (FIGS. 3 and 4) corresponding to the pair of chains provided in the upper and lower transferring units 21 and 23. Therefore, the transferring motors 15 are used to drive the palette 130 placed on the upper and lower transferring units 21 and 23 to be transferred along the transferring direction of the chain 14.

The power supply 17 is provided in the guide 11 and supplies a predetermined amount of power to the plurality of palettes 130. According to the present embodiment, the power supply 17 protrudes in three lines spaced apart from each other, and is coupled to the power connecting part 132 of the palette 130. The power supply 17 may include a plurality of power supplies 17 provided in the respective lines spaced apart from each other, so that they are not short-circuited by the power connecting part 132. Since the plurality of power supplies 17 are provided in the respective lines spaced apart from each other, a contact surface between the power supply 17 and the power connecting part 132 may be decreased. Therefore, when the palette 130 is transferred along the transferring unit 10, the friction and wear due to contact between the power supply 17 and the power connecting part 132 are decreased. Among the three power connecting parts 132, the middle is a ground terminal, and the opposite sides are positive and negative terminals.

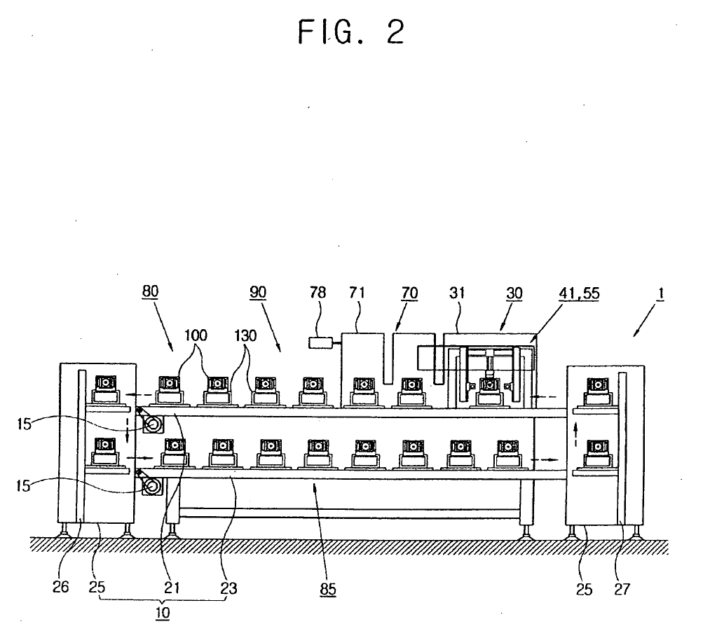

As illustrated in FIGS. 1 and 2, according to the present embodiment, the upper transferring unit 21 includes the lamp injecting part 80 to place the lamp unit 100 on the palette 130, the lamp control process unit 30, the lamp inspection process unit 70, and a lamp discharging part 90 to discharge the lamp unit 100 after the lamp control process and the lamp inspection process. Here, in the lamp injecting part 80 and the lamp discharging part 90 is provided the power supply 17 corresponding to only the middle ground line, so that not supply the no power is supplied to the palette 130. However, in the lamp control process 30 and the lamp inspection process 70 is provided the power supply 17 corresponding to all three lines to supply the power to the palette 130.

The lower transferring unit 23 includes the aging process unit 85, and is provided with the power supply 17 corresponding to three lines to supply the power from the power supply 17 to the palette 130 during the aging process of the aging process unit 85.

The vertical transferring unit 25 includes a lifting down transferring unit 26 to lift down the palette 130 toward the lower transferring unit 23 and supporting the lamp unit 100 received from the lamp injecting part 80 of the upper transferring unit 21, and a lifting up transferring unit 27 to lift up the lamp unit 100 after the aging process along with the palette 130 toward the upper transferring unit 21 as illustrated in FIG. 2.

The lifting down transferring unit 26 and the lifting up transferring unit 27 are provided at opposite sides of the upper transferring unit 21 and the lower transferring unit 23. The lifting down transferring unit 26 transfers the palette 130 while the palette 130 is not supplied with the power, conversely the lifting up transferring unit 27 transfers the palette 130 while the palette 130 is supplied with the power. That is, the power is supplied to the palette 130 from the aging process unit 85 to the lamp inspection process 70 even during the time the palette 130 is lifted up to the inspection process 70, so that the lamp 101 can emit light anytime therein.

In the lamp injecting part 80, the lamp unit 100 on the palette 130 is connected to the cable (not shown) of the lamp unit 100 through the connector 147 of the palette 130. At this time, the lamp 101 of the lamp unit 100 is temporarily coupled to the lamp housing 111 by the fastening screws 107 so that the lamp 101 is movable relative to the lamp housing 111. Alternatively, in the lamp injecting part 80, the lamp unit 100 can be seated on the palette 130 by automation.

In the lamp discharging part 90, the cable (not shown) is separated from the connector 147 to discharge the lamp unit 100 from the palette 130. At this time, an inspected result of the lamp inspection process 70 is checked through an inspection display 78, and the lamp unit 100 is sorted out according to the state thereof. Alternatively, in the lamp discharging part 90, the lamp unit 100 can be sorted out and discharged from the palette 130 by automation.

As illustrated in FIGS. 1, 2 and 4, in the aging process unit 85, the power is supplied to the palette 130 to make the lamp 101 emit light for a predetermined time. In the aging process unit 85, the lamp 101 is turned on, for example, for about three minutes depending on a normal operation of the lamp 101. However, in the aging process unit 85, the lamp 101 may be turned on for three minutes or a time period longer or shorter than three minutes depending on a normal operation of the lamp 101. In the aging process unit 85, an aging chamber 86 is provided to prevent the light emitted from the lamp 101 from being shown from the outside thereof.

As illustrated in FIGS. 3 and 8 through 10, the lamp control process unit 30 includes an illuminator 33 through which the light emitted from the lamp 101 of the lamp unit 100 passes, a screen 35 on which an image is formed by the light passed through the illuminator 33, a lamp control unit 41 to adjust the position of the lamp 101 against the lamp housing 111, a lamp fastening unit 55 fastening the lamp 101 to the lamp housing 111 in the state that the lamp 101 is adjusted in position by the lamp control unit 41, and a controller 51 to control the lamp control unit 41 and the lamp fastening unit 55 to bring the lamp 101 into focus on the basis of the image formed on the screen 35 and then fasten the lamp 101 to the lamp housing 111. Further, the lamp control process unit 30 is provided with a lamp control chamber 31 to prevent the light emitted from the lamp 101 from being shown from an outside of the lamp housing.

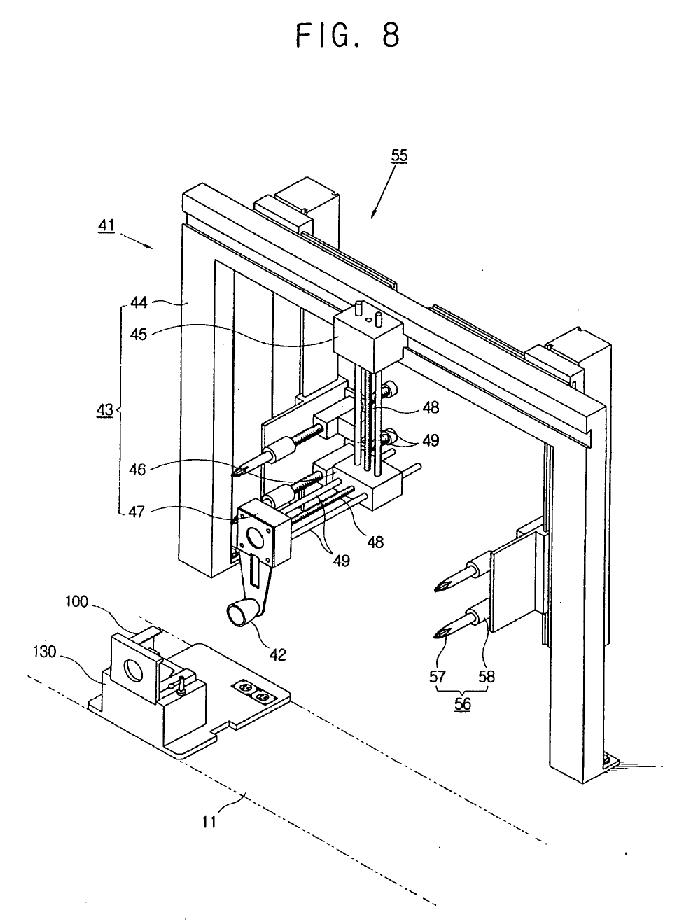

As illustrated in FIG. 8, the lamp control unit 41 is placed behind the lamp unit 100 to adjust the position of the lamp 101 relative to the lamp housing 111. Here, the lamp control unit 41 includes a lamp holder 42 to hold the lamp 101 in the state that the lamp 101 is movably coupled to the lamp housing 111, and a holder transferring part 43 to transfer the lamp holder 42 so that the lamp 101 can be moved relative to the lamp housing 111 in a direction transverse to the light.

The lamp holder 42 holds the back of the lamp 101. That is, the lamp holder 42 is in contact with the back of the lamp 101, and inhales the air around the lamp 101 to provide suction, thereby holding the lamp 101. However, the lamp holder 42 may hold the back of the lamp 101 by a pair of tongs, a magnetic force, etc.

The holder transferring part 43 moves the lamp holder 42 in three axis directions. For example, the holder transferring part 43 moves frontward and backward to control the lamp holder 42 to hold the lamp 101, and moves left and right, and up and down allowing the lamp 101 to move relative to the lamp housing 111 in the direction transverse to the light which passes through the housing through part 112. The holder transferring part 43 includes a supporting frame 44, a holder left and right transferring body 45 coupled to the supporting frame 44 to move in the left and right directions, a holder up and down transferring body 46 coupled to the holder left and right transferring body 45 to move in the up and down directions, and a holder front and back transferring body 47 supporting the lamp holder 42 and coupled to the holder up and down transferring body 46 to move in the front and back directions. Further, the holder transferring part 43 includes a driving motor (not shown) provided in the holder up and down transferring body 46 and the holder front and back transferring body 47 and allowing them to move relative to each other, and a transferring screw 48 moved by the driving motor, and a guide member 49 to guide the relative movement due to the transferring screw 48. The holder left and right transferring body 45 can move with respect to the supporting frame 44 by a linear motor (not shown). Alternatively, the holder left and right transferring body 45 may move by the driving motor and the transferring screw like the holder up and down transferring body 46 and the holder front and back transferring body 47. Likewise, the holder up and down transferring body 46 and the holder front and back transferring body 47 may move with respect to each other by the linear motor.

Therefore, the lamp 101 is held in the lamp holder 42 by the holder transferring part 43, and can be moved up, down, left and right relative to the lamp housing 111.

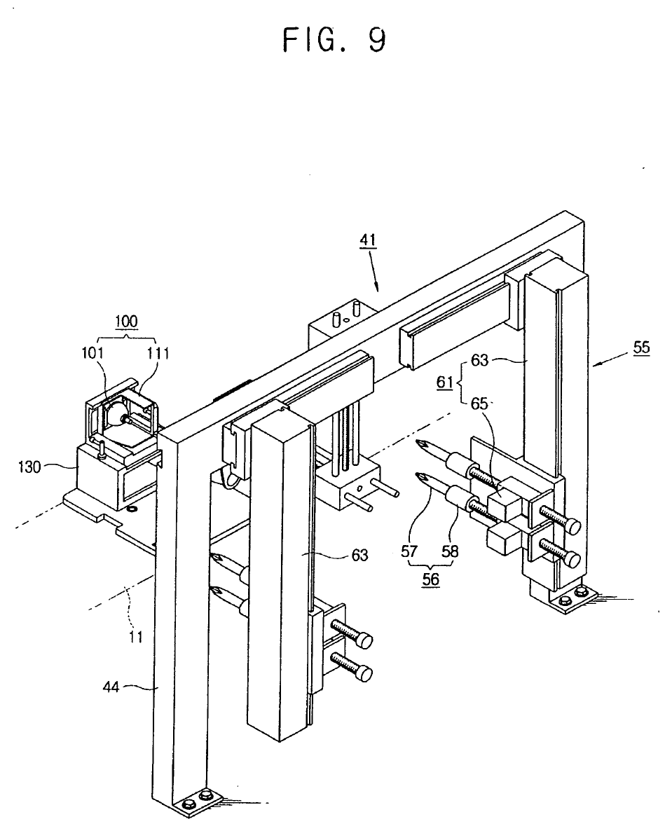

As illustrated in FIG. 9, the lamp fastening unit 55 is placed behind the lamp unit 100 so that the lamp 101 adjusted in position by the lamp control unit 41 is fastened to the lamp housing 111. The lamp fastening unit 55 includes a screw fastener 56 to fasten the fastening screws 107, which allows the lamp 101 to be temporarily fastened to the lamp housing 111 and not to move relative to the lamp housing 111, and a fastener transferring part 61 to transfer the screw fastener 56.

The screw fastener 56 includes a screw driver 57 provided in a front portion to fasten the coupling screws 107, and a screw driver driving part 58 to rotatably support the screw driver 57. Here, four screw fasteners 56 are provided corresponding to four coupling screws 107. Alternatively, two screw fasteners or one screw fastener may be provided.

The fastener transferring part 61 includes a fastener left and right transferring body 63 movable left and right relative to the supporting frame 44, and a fastener front and back transferring body 65 coupled to the fastener left and right transferring body 63 to move front and back relative to the fastener left and right transferring body 63. Further, the fastener transferring part 61 may include a linear motor (not shown) to move the fastener left and right transferring body 63 and the fastener front and back transferring body 65 relatively to each other.

The fastener front and back transferring body 65 corresponds to the number of the screw fasteners 56. For example, four fastener front and back transferring bodies 65 may be provided corresponding to four screw fasteners 56.

The fastener left and right transferring body 63 may form a pair to be placed in left and right sides of the supporting frame 44. The pair of fastener left and right transferring bodies 63 may support one pair of fastener front and back transferring bodies 65.

Therefore, the lamp 101 is firmly fastened to the lamp housing 111 by the lamp fastening unit 55.

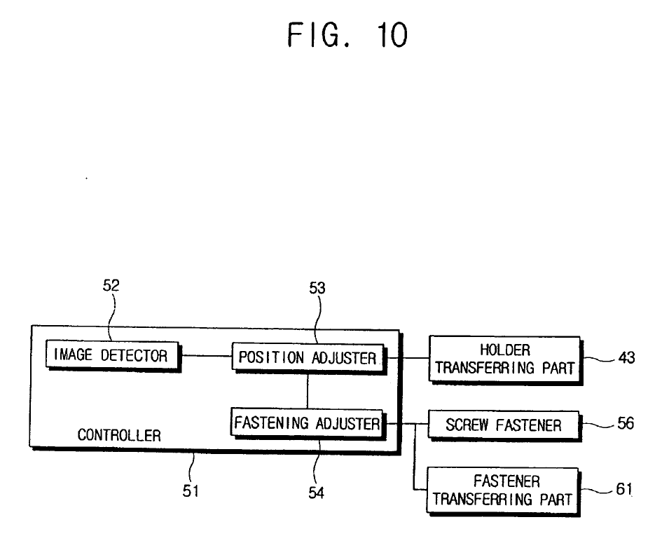

As illustrated in FIG. 10, the controller 51 includes an image detector 52 to detect an image formed on the screen 35 of the lamp control unit 41, and a position adjuster 53 to control the holder transferring part 43 on the basis of the image detected by the image detector 52. Here, the controller 51 further includes a fastening adjuster 54 to control the fastener transferring part 61 and the screw fastener 56 so that the fastening screws 107 are fastened in the state that the lamp 101 is adjusted in position by the position adjuster 53.

The image detector 52 detects the image projected on the screen 35 formed by the light emitted from the lamp unit 100 that passes through the illuminator 33. Here, the image detector 52 is provided in the lamp control chamber 31 to detect the image projected on the screen 35. The image detector 52 transmits the detected image to the position adjuster 53. On the screen 35, the same patterns may appear to be spaced apart from each other, and the patterns can be formed by the foregoing lamp driving circuit 125.

The position adjuster 53 reads the image detected by the image detector 52 and controls the holder transferring part 43, thereby focusing the lamp 101 temporarily coupled to the lamp housing 111. Here, the position adjuster 53 determines whether the patterns of the image transmitted from the image detector 52 have a space within a predetermined reference space range in the up, down, left and right directions. As a result, when the space between the patterns deviates from the reference space range, the position adjuster 53 measures a deviated degree of the patterns and controls the holder transferring part 43 on the basis of the deviated degree. The position adjuster 53 controls the holder transferring part 43 and moves the lamp 101 relative to the lamp housing 111. The position adjuster 53 controls the holder transferring part 43 so that the lamp holder 42 holds the lamp 101, and then moves the lamp holder 42 frontward to the lamp 101. Then, the position adjuster 53 controls the holder transferring part 43 to move the lamp holder 42 in the left, right, up and down directions on the basis of the deviated degree with respect to the reference space range. Then, the image detector 52 detects the image on the screen 35, and transmits the detected image to the position adjuster 53. Then, the position adjuster 53 determines the transmitted image and controls the holder transferring part 43 again. The position adjuster 53 repeats controlling the holder transferring part 43 until the space between the patterns is within the reference space range. Further, when the space between the patterns is within the reference space range, the position adjuster 53 may control the holder transferring part 43 so that the screw fastener 56 more easily and firmly fastens the fastening screws 107, thereby allowing the lamp 101 to closely contact the lamp housing 111.

The image detector 52 and the position adjuster 53 are repeatedly operated to bring the lamp 101 temporarily coupled to the lamp housing 111 into focus until the space between the patterns of the image detected by the image detector 52 is within the reference space range with respect to the up, down, left and right directions. Here, the reference space range can be obtained by adding an allowable error to an average space between the patterns of the detected image, and may vary according to the kinds of the lamp unit 100.

The fastening adjuster 54 controls the fastener transferring part 61 and the screw fastener 56 to firmly fasten the lamp 101 temporarily coupled to the lamp housing 111 after the position adjuster 53 completely adjusts the position of the lamp 101 against the lamp housing 11. Here, the fastening adjuster 54 first controls the fastener transferring part 61 to move the screw fastener 56 in the left and right directions and then in the front direction to make the screw fastener 56 contact the fastening screws 107. Then, the fastening adjuster 54 drives the screw fastener 56 so that the fastening screws 107 firmly fasten the lamp 101 to the lamp housing 111.

According to the present embodiment, the lamp inspection process of the lamp inspection process unit 70 is provided to inspect the luminous intensity and/or the flicker of the lamp unit 101. Further, the lamp inspection process unit 70 may be provided to inspect other items required in the lamp unit 100.

As illustrated in FIGS. 2 and 3 the lamp inspection process unit 70 includes the illuminator 33, a projection lens 73 to project the light passed through the illuminator 33, an illumination sensor 75 to sense the luminous intensity of the light projected from the projection lens 73, and a flicker sensor 76 to sense the flicker of the light projected from the projection lens 73. Further, the lamp inspection process unit 70 can include the inspection display 78 that receives sensed signals from the illumination sensor 75 and the flicker sensor 76 and displays the sensed results. Also, the lamp inspection process unit 70 is provided with a lamp inspection chamber 71 to prevent the light emitted from the lamp 101 from being shown from the outside.

The illumination sensor 75 senses the brightness of the light emitted from the lamp 101 and displays the sensed results on the inspection display 78 in the lamp discharging part 90, and thus the lamp unit 100 may be sorted out and discharged based on the sensed results displayed on the inspection display 78.

The flicker sensor 76 is used to sense a flicker phenomenon, that is, a wavering visual sensation of a periodic change in the brightness of the light emitted from the lamp 101. A value sensed by the flicker sensor 76 is displayed on the inspection display 78. Here, the value is compared with a predetermined reference value and its acceptability is then determined. The acceptability of the sensed value of the flicker sensor 76 is displayed in the inspection display 78 in the lamp discharging part 90, and thus the lamp unit 100 may be sorted out and discharged based on the sensed value displayed on the inspection display 78.

With this configuration, operations of the lamp assembling apparatus 1 according to an embodiment of the present general inventive concept will be described below with reference to FIG. 2. The lamp unit 100 is seated on the palette 130 in the lamp injecting part 80, and the cable of the lamp unit 100 is connected to the connector 147 of the palette 130. At this time, the lamp 101 of the lamp unit 100 is loosely and temporarily coupled to the lamp housing 111. Then, the lamp unit 100 is transferred to the lower transferring unit 23 while being seated on the palette 130, so that the aging process of the aging process unit 85 can be performed. After the aging process, the lamp unit 100 is transferred to the lamp control process of the lamp control process unit 30 while being seated on the palette 130. In the lamp control process, the lamp control unit 41 and the controller 51 control the position of the lamp 101 against the lamp housing 111 to bring the lamp 101 into focus. Further, the controller 51 controls the lamp fastening unit 55 to firmly fasten the lamp 101 to the lamp housing 111. After the lamp control process, the lamp unit 100 is transferred to the lamp inspection process unit 70 while being seated on the palette 130. In the lamp inspection process of the lamp inspection process unit 70, the illumination sensor 75 and the flicker sensor 76 sense the luminous intensity and the flicker of the lamp unit 100, respectively, and the sensed results are displayed on the inspection display 78. The state of the lamp unit 100 is displayed in the inspection display 78 in the lamp discharging part 90, and thus the lamp unit 100 may be sorted out and discharged based on the state displayed in the inspection display 78.

Therefore, the lamp assembling apparatus according to an embodiment of the present general inventive concept includes the lamp control unit 41, the lamp fastening unit 55 and the controller 51 to adjust the position of the lamp 101 and then fasten the lamp 101 to the lamp housing 111, so that the lamp 101 is automatically mounted to the lamp housing, thereby enhancing productivity and securing uniform quality in the lamp assembling process.

Further, the lamp inspection process includes the illumination sensor, the flicker sensor and the inspection display, so that the luminous intensity and the flicker of the lamp unit are automatically inspected, thereby easily inspecting the lamp unit and enhancing the inspection quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A lamp assembling apparatus to assemble a lamp unit usable with an optical engine, which comprises a lamp, and a lamp housing to support the lamp, the lamp assembling apparatus comprising:
an illuminator through which light emitted from the lamp of the lamp unit passes;
a screen on which an image is formed by the light passed through the illuminator;
a lamp control unit to adjust a position of the lamp against the lamp housing using the light;
a lamp fastening unit to fasten the lamp to the lamp housing when the lamp position is adjusted in position by the lamp control unit; and
a controller to determine a state of the lamp with respect to the lamp unit according to the image formed on the screen, and to control the lamp control unit and the lamp fastening unit to bring the lamp into focus and fasten the lamp to the lamp housing according to the state of the lamp.

2. The lamp assembling apparatus according to claim 1, wherein the lamp control unit comprises:
a lamp holder to hold the lamp in a state that the lamp is movably coupled to the lamp housing; and
a holder transferring part to transfer the lamp holder to move the lamp relative to the lamp housing in a direction transverse to the light emitted from the lamp.

3. The lamp assembling apparatus according to claim 2, wherein the controller comprises:
an image detector to detect the image formed on the screen; and
a position adjuster to control the holder transferring part by determining the image detected by the image detector.

4. The lamp assembling apparatus according to claim 3, wherein the lamp housing comprises a plurality of coupling parts to which a plurality of screws are coupled, and the lamp comprises a plurality of coupling holes corresponding to the plurality of coupling parts and each coupling hole having a larger diameter than a threaded part of the screw.

5. The lamp assembling apparatus according to claim 4, wherein the lamp fastening unit comprises:
a screw fastener to fasten the screw to prevent the lamp from moving relative to the lamp housing;
a fastener transferring part to support and transfer the screw fastener to allow the screw fastener to fasten the screw.

6. The lamp assembling apparatus according to claim 5, wherein the controller further comprises:
a fastening adjuster to control the fastener transferring part and the fastener to fasten the screw in a state that the lamp is adjusted in position by the position adjuster.

7. The lamp assembling apparatus according to claim 6, wherein the holder transferring part transfers the lamp holder in three axis directions.

8. The lamp assembling apparatus according to claim 1, further comprising:
a palette to support the lamp unit, and
a transferring unit which comprises:
a guide to support and guide the palette, and
a transferring member to transfer the palette along the guide.

9. The lamp assembling apparatus according to claim 8, wherein the transferring unit comprises a power supply placed along the guide to supply power to the palette, and the palette comprises a power connecting part contactable with the power supply and a connector electrically connected to the power connecting part and coupled to a cable of the lamp unit.

10. The lamp assembling apparatus according to claim 9, further comprising:
an aging process unit to age the lamp unit for a predetermined time;
a lamp control process unit to adjust the position of the lamp and fasten the lamp using the lamp control unit and the lamp fastening unit after the lamp is aged; and
a lamp inspection process unit to inspect the lamp unit after a lamp control process of the lamp control process unit.

11. The lamp assembling apparatus according to claim 10, wherein the transferring unit transfers the palette to the aging process unit, the lamp control process unit and the lamp inspection process unit.

12. The lamp assembling apparatus according to claim 11, wherein the aging process unit, the lamp control process unit and the lamp inspection process unit comprise aging, lamp control and lamp inspection chambers, respectively, to prevent the light emitted from the lamp from being shown from an area outside of the chambers.

13. The lamp assembling apparatus according to claim 8, wherein the palette comprises:
an accommodating part to accommodate a ballast and a lamp driving circuit of the lamp unit therein.

14. The lamp assembling apparatus according to claim 10, wherein the lamp inspection process unit inspects at least one of a luminous intensity and a flicker of the light emitted from the lamp.

15. The lamp assembling apparatus according to claim 14, wherein the lamp inspection process unit further comprises:
a projection lens to project the light passed through the illuminator,
an illumination sensor to sense the luminous intensity of the light projected from the projection lens,
a flicker sensor to sense the flicker of the light projected from the projection lens, and
an inspection display to receive and display sensed values from the illumination sensor and the flicker sensor.

16. The lamp assembling apparatus according to claim 8, wherein the transferring member comprises:
a chain contactable with the palette, and
a transferring motor to transfer the chain.

17. A lamp assembling apparatus comprising:
a lamp injecting part to provide a lamp unit in which a lamp is temporarily coupled to a lamp housing;
an aging process unit to control an aging process of the lamp of the lamp unit;
a control process unit having an image unit to form an image of the lamp unit using light, a lamp control unit to adjust a position of the lamp with respect to the lamp housing using the light between the lamp and the lamp housing, and a controller to bring the lamp into focus according to the image;
an inspection process unit to inspect an assembly state of the lamp unit; and
a lamp discharging part to discharge the lamp unit.

18. The lamp assembling apparatus of claim 17, further comprising:
an upper frame on which the lamp injecting part, the control process unit, the inspection process unit, and the lamp discharging unit are disposed;
a lower frame on which the aging process unit is disposed; and
a lifting unit to connect the upper and lower frames to move the lamp unit therebetween.

19. The lamp assembling apparatus of claim 17, wherein the control process unit further comprises:
a lamp fastening unit to fix the lamp to the lamp housing after the position of the lamp is adjusted with respect to the lamp housing.

20. A method of a lamp assembling apparatus, the method comprising:
forming an image on a screen by a light projected by a lamp;
adjusting a position of the lamp against a lamp housing using the light;
fastening the lamp to the lamp housing when the lamp position is adjusted in position;
determining a state of the lamp according to the image formed on the screen; and
bringing the lamp into focus and fastening the lamp to the lamp housing according to the state of the lamp.
